(19) United States
(12) Patent Application Publication
(10) Pub. No.: US 2015/0017436 A1
(43) Pub. Date: Jan. 15, 2015

(54) Protective coating for cords

(71) Applicant: OTIS ELEVATOR COMPANY, Farmington, CT (US)

(72) Inventors: Gopal R. Krishnan, Wethersfield, CT (US); Wayde R. Schmidt, Pomfret Center, CT (US)

(21) Appl. No.: 14/371,863

(22) PCT Filed: Jan. 12, 2012
(86) PCT No.: PCT/US2012/021064

§ 371 Date: Jul. 11, 2014

(51) Int. Cl. D07B 1/06; D07B 1/00; B05D 1/28; D07B 1/22; B05D 3/00; B05D 1/02

(52) U.S. Cl. CPC D07B 1/0666; B05D 3/007; B05D 1/02; B05D 1/28; D07B 1/22; D07B 1/005; D07B 2501/2007
USPC 428/365; 427/385.5; 427/388.1; 428/394

(57) ABSTRACT

A method for making a belt or rope includes providing a plurality of cords; engaging the plurality of cords with a jacket; and providing an organic-containing material to at least one of the cords and the jacket.

### FIELD OF INVENTION

The subject matter disclosed herein relates generally to the field of lifting and/or suspending members used, for example, in elevator systems, and more particularly, to lifting and/or suspending members having metal cords with an organic or metal-organic coating.

### DESCRIPTION OF RELATED ART

Elevator systems utilize lifting and/or suspending members, such as belts or ropes. The belts or ropes can be operably connected to an elevator car, and routed over one or more sheaves to propel the elevator along a hoistway. As an example, the belt can include polyurethane-coated steel cords having a plurality of wires. The steel wires are often arranged into one or more strands and the strands are then arranged into one or more cords. A woven elevator belt such as a woven belt disclosed in U.S. Pat. No. 1,475,250 utilizes polyester or other synthetic fabric to hold the steel wire based cords within a weave construction. Improvements in a belt having lifting or suspending members with metal cords in a coating would be well received in the art.

### BRIEF SUMMARY

According to one aspect of the invention, a belt or rope includes a plurality of cords; and a jacket engaging the cords; where at least one of the cords and the jacket include at least one organic-containing material.

According to another aspect of the invention, a method for making a belt or rope includes providing a plurality of cords; engaging the plurality of cords with a jacket; and providing an organic-containing material to at least one of the cords and the jacket.

Other aspects, features, and techniques of the invention will become more apparent from the following description taken in conjunction with the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 schematically shows selected portions of an example elevator system that could utilize a lifting and/or suspending member designed according to an embodiment of this invention; and

FIG. 2 schematically illustrates selected portions of an example elevator belt according to an embodiment of the invention.

### DETAILED DESCRIPTION

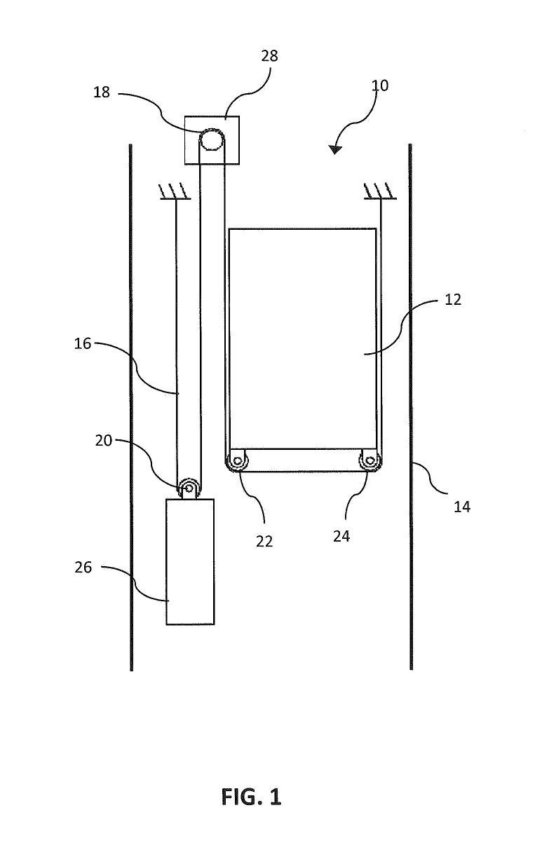

Referring now to the drawings, FIG. 1 illustrates a schematic of an example traction elevator system 10 including an elevator car 12 coupled to one or more lifting and/or suspending members. The lifting and/or suspending members could be ropes or belts 16 according to an embodiment of the invention. The elevator car 12 is operatively suspended or supported in a hoistway 14 with the one or more belts 16. The one or more elevator belts 16 are routed around the various components of the elevator system 10 by interacting with a traction sheave 18 and, possibly, one or more idler sheaves, such as idler sheaves 20, 22, 24 that can be substantially similar. The one or more belts 16 may also be connected to a counterweight 26, which is used to help balance the elevator system 10 and reduce the difference in belt tension on both sides of the traction sheave 18 during operation. The one or more elevator belts 16 can support the weight of the car 12 and the counterweight 26. Also shown, the traction sheave 18 is driven by a machine 28. Movement of traction sheave 18 by the machine 28 drives, moves and/or propels (through traction) the one or more elevator belts 16 to achieve the desired movement and placement of the elevator car 12 within the hoistway 14.

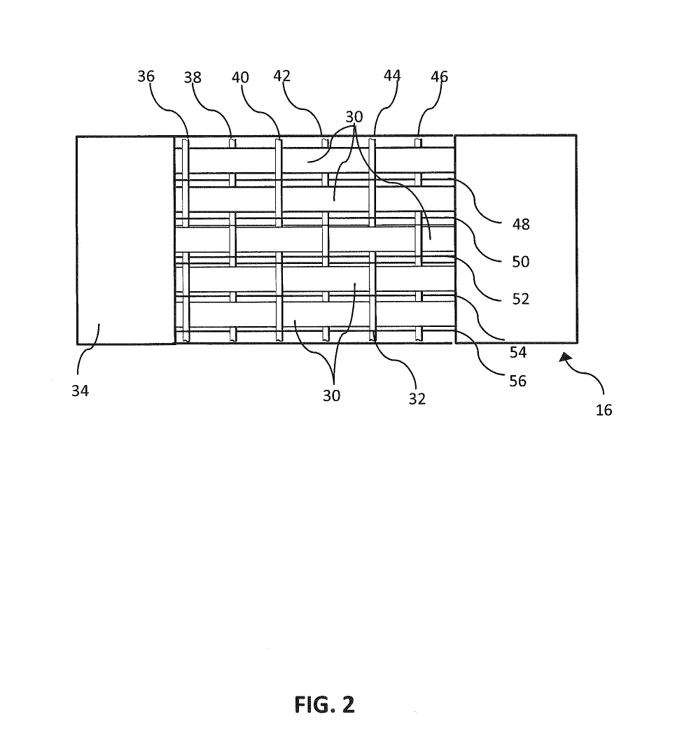

FIG. 2 shows an example of a woven elevator belt 16 having at least partially exposed woven fabric 32 according to an embodiment of the invention. Particularly, the elevator belt 16 includes a plurality of cords or tension elements 30 that are arranged generally parallel to each other and extend in a longitudinal direction that establishes a length dimension of the elevator belt 16. In one example, the plurality of cords or tension members 30 can be constructed from a plurality of steel wires having a diameter in the range of 0.15 mm to 0.4 mm The plurality of steel wires can be formed into a strand, and a plurality of strands can be formed into a cord. In other embodiments, the plurality of cords or tension members 30 can be made from other metal alloys such as, for example, carbon steel, iron alloys, nickel alloys or aluminum alloys, or from a combination of metal wires and non-metallic fibers without departing from the scope of the invention. Further, the plurality of cords or tension members 30 are assembled into the elevator belt 16 by weaving the plurality of cords or tension members 30 together with weave fibers forming a suitable woven fabric 32. The fibers, or the fabric 32 formed by the fibers, could be impregnated with at least one protective coating that protects the cords from corrosion during operation of the belt 16 in an elevator system 10. In another embodiment, synthetic fiber ropes coated with one or more coatings specifically designed for fiber ropes can be used instead of the plurality of cords with steel wires without departing from the scope of the invention.

The elevator belt 16 could include at least one generally wear-resistant fabric 32 such as common synthetic fabrics based on nylon, polyester, olefin, acrylic, and cellulose, and specialty fabrics including aramids, that is woven with the plurality of cords or tension members 30 and generally surrounded by an elastomer 34 to form a jacket. But, in another embodiment, the plurality of cords or tension members 30 and woven fabric 32 is encapsulated in the elastomer 34. In an embodiment, the material used to form the woven fabric 32 is a synthetic material that is flexible as well as impregnable to coatings such as, for example, a polyester material. But, other materials may be used without departing from the scope of the invention. The fabric 32 can be woven together from weft and warp elements. In one non-limiting example, a plurality of weft elements 36, 38, 40, 42, 44, 46 are bound to a plurality of warp elements 48, 50, 52, 54, 56 and the plurality of cords 30. In one arrangement, the weft elements 36-46 are arranged transversely to the plurality of cords 30 and the warp elements 48-56. In this arrangement, the woven fabric 32 substantially retains the plurality of cords 30 in position. The phrase “substantially retains” means that the woven fabric 32 sufficiently engages the cords 30 such that the plurality of cords 30 do not pull out of, or move relative to, the woven fabric 32 during the application of a load on the woven elevator belt 16. The cords 30 can be the primary load bearing structure of the elevator belt 16. In some examples, the woven fabric 32 does not support any of the weight of the elevator car 12 (FIG. 1) or the counterweight 26. Nevertheless, the woven fabric 32 can form part of the load path. Further, the jacket 34, if present, defines the traction surface of the elevator belt 16. In one arrangement, the jacket 34 can be a polymer, such as an elastomer coating applied to the woven fabric 32 using, for example, an extrusion or a mold-wheel process to encapsulate the woven fabric 32. In other examples, the jacket 34 can be two or more layers using the same elastomeric materials or dissimilar materials and/or a film. Other jacket materials include rubber-based emulsions, such as latexes and ethylene propylene diene monomer that can be applied in a solution followed by a curing step at an elevated temperature.

In an exemplary process for manufacturing the elevator belt 16, one or more self-assembling organic or metal-organic coatings can be first applied as a protective coating to the surface of the plurality of wires, strands and/or cords or tension members 30 prior to weaving the fabric 32. Self-assembling as used herein refers to intermolecular self-assembly, which is a process by which molecules adopt a defined arrangement without guidance or management from an outside source. The coating provides corrosion resistance to the surface of the plurality of wires, strands and/or cords or tension members 30. The process is initiated by applying at least one relatively thin layer of self-assembling organic or metal-organic coating. “Relatively thin” as used herein includes a range of coating layer thicknesses from about 10 angstroms (about 1 nanometers) to about 1 micron (about 1000 nanometers), and may include a single or multiple monolayers of the coating materials on the surface of the plurality of cords or tension members 30. The organic or metal-organic monolayer coatings are selected to be readily adsorbed, either through chemical bonding or by physical interactions or by both, onto the surface of the plurality of wires, strands and/or cords or tension members 30 and/or to be compatible with the elastomeric coating that encapsulates the fabric 32. In an embodiment, the organic or metal-organic monolayer coatings utilized are chemicals of alkyl-terminated phosphonic acid, such as dodecyl-phosphonic acid, thiophene-hexane-phosphonic acid, or similar types of chemicals. In another exemplary embodiment, the coatings are latex preferring silane coupling agents such as, for example, 3-(trimethoxysilyl) propyl methacrylate or siloxane modified latex obtained by grafting a cyclic siloxane monomer onto the silane coupling agent. In one example, the plurality of cords or tension members 30 are dipped into the organic or metal-organic coating material and allowed to dry in air if the coatings are thin. In another example, the organic or metal-organic coating material is spray coated or painted onto the surface of the plurality of cords or tension members 30. “Thin” as used herein includes a range of coating layer thicknesses from about 10 angstroms (about 1 nanometers) to about 1 micron (about 1000 nanometers), and may include a single or multiple monolayers of the coating materials on the surface of the plurality of cords or tension members 30. Other examples include accelerating the drying or additional post-curing of the coating material or materials in an oven with the application of temperature, pressure, light, or a combination of these methods during the drying or post-curing process.

In another exemplary embodiment, the organic or metal-organic monolayer coatings are provided as a plurality of dissimilarly charged species, and can be deposited in a readily automated, sequential process known to those in the art as a layer-by-layer process. The “layer-by-layer process” is a process that uses ionic interactions that result from an interaction between molecular groups containing net permanent opposite charges, which results in a structured coating that self-assembles. In one example, the plurality of wires, strands and/or cords or tension members 30 are treated to render the surface generally negatively charged. In a following step and particularly, a first charged layer of organic or metal-organic monolayer species is deposited onto the plurality of wires, strands and/or cords or tension members 30 by, in one example, passing through a liquid bath containing a positively charged species of the organic or metal-organic monolayer coating source. In one example, the positively charged species can be a hydrolyzable species or polyelectrolyte containing amine functionality, such as an amine-derivative of a silane coupling agent. Thereafter, a subsequent negatively charged organic or metal-organic monolayer species source is deposited onto the plurality of wires, strands and/or cords or tension members 30 in a second liquid bath containing the negatively charged species. In one example, the negatively charged species can be a hydrolyzable species or polyelectrolyte containing hydroxyl or carboxylic acid functionality, such as hydroxyl- or carboxyl-derivatives of silane coupling agents. The negatively charged species will attract the positively charged species to form a protective coating once cured. In some embodiments, intermediate washing steps may be used. In another example, the plurality of wires, strands and/or cords or tension members 30 are first treated to render the surface generally positively charged, and in subsequent steps coatings are deposited in reverse charge order, that is the first coating will contain negatively charged species. Thereafter, in an embodiment, the wires, strands and/or cords or tension members 30 having the coatings are tightly woven together with the fabric 32. Weaving the fabric 32 with the plurality of cords 30 practically covers the surface of the plurality of cords 30 with the fabric 32 and locks the plurality of cords 30 within the weave configuration. The plurality of cords 30 and the fabric 32 can be thereafter coated with another final elastomeric coating in order to generally surround or encapsulate the fabric 32 and/or define the desired friction characteristic or traction of the elevator belt 16. One example includes applying a carboxylated latex coating to the woven fabric 32 followed by curing including drying the latex coating in a controlled temperature and relative humidity environment for a predetermined curing time. In another embodiment, an elastomeric coating such as urethane including thermoplastic polyurethane or a self-assembling organic or metal-organic coating can be can be used as the final coating.

In another exemplary process for manufacturing the elevator belt 16, the protective organic or metal-organic material is applied only to the woven fabric 32, which is formed by weaving the plurality of cords or tension members 30 together with weave fibers. Particularly, the plurality of cords or tension members 30 are tightly woven together with the weave fibers and at least one low viscosity organic or metal-organic monolayer material source with a viscosity in the range of about 100 centipoise (about 100 millipascal second) to about 700 centipoise (about 700 millipascal second) is applied to the fabric 32. In an embodiment, the organic or metal-organic monolayer source material utilized are chemicals of alkyl-terminated phosphonic acid, such as dodecyl-phosphonic acid, thiophene-hexane-phosphonic acid, or a latex preferring silane coupling agent such as, for example, 3-(trimethoxysilyl) propyl methacrylate or siloxane modified latex obtained by grafting a cyclic siloxane monomer onto the silane coupling agent. The organic or metal-organic monolayer coating source is applied under appropriate time and temperature to allow for complete wetting and penetration of the woven fabric 32. Thereafter, the fabric 32 is allowed to dry in air or by accelerating the drying in an oven. The fabric 32 is thereafter coated with a final elastomeric coating to encapsulate the fabric 32. A carboxylated latex coating such as urethane including thermoplastic polyurethane can be used as the final elastomeric coating. The carboxylated latex coating is cured in a controlled temperature and relative humidity environment for a predetermined time to encapsulate the fabric 32. In another embodiment, a self-assembling organic or metal-organic coating may be applied to the fabric 32 prior to applying the final elastomeric coating.

In another exemplary process for manufacturing the elevator belt 16, the protective organic or metal-organic coating or coatings described above are provided with the elastomeric coating and applied as a mixture to the woven fabric 32. Particularly, the organic or metal-organic coating or coatings and the elastomeric coating mixture is applied to the woven fabric 32 comprising the cords or tension members 30 by, in one embodiment, immersing the woven fabric 32 into the mixture and allowing the fabric 32 to cure for a predetermined time and temperature. In an embodiment, the organic or metal-organic monolayer coating source utilized are chemicals of alkyl-terminated phosphonic acid, such as dodecyl-phosphonic acid, thiophene-hexane-phosphonic acid, or similar types of chemicals, or are a latex preferring silane coupling agent such as, for example, 3-(trimethoxysilyl) propyl methacrylate or siloxane modified latex obtained by grafting a cyclic siloxane monomer onto the silane coupling agent. Over time, the organic or metal-organic coatings migrate to the surface of the cords or tension members 30 thereby coating the surface of the plurality of cords or tension members 32 and providing a protective bather against corrosion. In another exemplary embodiment, the organic or metal-organic monolayer coatings are provided as a plurality of dissimilarly charged species. Particularly, a first charged layer of organic or metal-organic monolayer species is provided with a negatively charged organic or metal-organic monolayer species in the mixture. The negatively charged species will attract the positively charged species and migrate to the surface of the plurality of cords 30 to be adsorbed on its surface. It is to be appreciated that the coating process may be implemented in fewer steps by applying the protective organic or metal-organic coating or coatings as a mixture with the elastomeric coating.

The technical effects and benefits of exemplary embodiments include a method for coating cords in a woven elevator belt include applying self-assembling organic or metal-organic coatings to the surface of the plurality of cords prior to weaving the cords with a fabric material. In another embodiment, the organic or metal-organic coatings can be applied as a low viscosity application after weaving the fabric material onto the cords. A final latex coating is applied after the organic or metal-organic coatings have dried or cured.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while various embodiment of the invention have been described, it is to be understood that aspects of the invention may include only some of the described embodiments. Accordingly, the invention is not to be seen as limited by the foregoing description, but is only limited by the scope of the appended claims.

1. A belt or rope, comprising:
a plurality of cords; and
a jacket engaging the cords;
wherein at least one of the cords and the jacket include at least one organic-containing material.

2. The belt or rope of claim 1, wherein the material is an alkyl-terminated phosphonic acid.

3. The belt or rope of claim 1, wherein the organic-containing material is one of a 3-trimethoxysilyl-propyl methacrylate or a cyclic siloxane monomer grafted onto a silane coupling agent.

4. The belt or rope of claim 1, wherein the organic-containing material includes each of a positively charged species and a negatively charged species of a metal-organic compound.

5. The belt or rope of claim 1, wherein the positively charged species is one of a hydrolyzable species or polyelectrolyte containing amine functionality and the negatively charged species is one of a hydroxyl- or carboxyl-derivative of silane.

6. The belt or rope of claim 1, wherein the organic-containing material is a coating on the wires.

7. The belt or rope of claim 1, wherein the jacket includes a woven fabric and the material is applied to the fabric.

8. A method for making a belt or rope, comprising:
providing a plurality of cords including a plurality of wires;
engaging the plurality of cords with a jacket; and
providing an organic-containing material to at least one of the cords and the jacket.

9. The method of claim 8, wherein the engaging of the cords further comprises:
weaving a plurality of weave fibers with the plurality of wires to form a woven fabric; and
coating the woven fabric with the organic-containing material and an elastomer.

10. The method of claim 8, wherein the providing of the organic-containing material further comprises coating the surface of the plurality of wires prior to the engaging step.

11. The method of claim 8, wherein the providing of the organic-containing material further comprises coating the surface of the plurality of wires subsequent to the engaging step.

12. The method of claim 8, further comprising providing the organic-containing material that includes an alkyl-terminated phosphonic acid.

13. The method of claim 8, further comprising providing the organic-containing material that is one of a 3-trimethoxysilyl-propyl methacrylate or a cyclic siloxane monomer grafted onto a silane coupling agent.

14. The method of claim 9, further comprising curing the coated woven fabric in an environment including at least one of air, temperature, light, and relative humidity.

15. The method of claim 8, further comprising providing the plurality of cords that are of a metal alloy.

16. The method of claim 8, further comprising providing the organic-containing material that includes each of a positively charged species and a negatively charged species of a metal-organic compound.

17. The method of claim 16, wherein the positively charged species is one of a hydrolyzable species or polyelectrolyte containing amine functionality and the negatively charged species is one of a hydroxyl- or carboxyl-derivative of silane.

18. The method of claim 8, further comprising drying the organic-containing material in an environment including at least one of air, temperature, or light for facilitating wetting.

19. The method of claim 8, further comprising curing the organic-containing material in an environment including a temperature and relative humidity.
